(19) United States
(12) Patent Application Publication
(10) Pub. No.: US 2009/0120079 A1
(43) Pub. Date: May 14, 2009

(54) EXHAUST GAS TREATMENT

(75) Inventors: Clive Buckberry, Warwick (GB); Stuart Charles Davey, Warwickshire (GB); James Coates, Cambridgeshire (GB); Mark Sealy, Warwickshire (GB)

Correspondence Address: THE OLLILA LAW GROUP LLC, 2060 BROADWAY, SUITE 300, BOULDER, CO, 80302, US

(73) Assignee: IMI VISION LIMITED, Alcester, Warwickshire (GB)

(21) Appl. No.: 11/815,482

(22) PCT Filed: Feb. 16, 2006
(86) PCT No.: PCT/GB06/00541

§ 371 Date: Mar. 18, 2008

(30) Foreign Application Priority Data
Feb. 16, 2005 (GB) 0503181.0
Oct. 12, 2005 (GB) 0520721.2

(51) Int. Cl. F01N 3/10; B01J 19/00

(52) U.S. Cl. 60/303; 422/148

(57) ABSTRACT

A thermo-hydrolysis reactor (1) for producing ammonia-containing gas by heating an aqueous solution of urea is described. The reactor (1) comprises an elongate vessel (2) having a middle tubular section, an enlarged lower section (4) having an inlet (5) for the urea solution, and an enlarged upper section (3) having an outlet (6) therein for the ammonia-containing gas. The reactor (1) is adapted such that, in use, heat transmitted through the walls of the reactor (1) from an external heat source heats the urea solution causing it to hydrolyse producing the ammonia-containing gas.

The present invention relates to an apparatus for producing ammonia, in particular an apparatus for producing ammonia onboard a vehicle for use in the removal of Nitrogen Oxides (NOx) from the exhaust gasses of the vehicle's internal combustion (IC) engine.

In the selective catalytic reduction (SCR) of NOx in exhaust gas, ammonia is used as a reagent to react with NOx within the gas as it passes through a catalyst converting it to nitrogen and water. Current and future legislation will control the allowable NOx output of commercial vehicles and thus NOx removal is becoming increasingly necessary. As ammonia is classified as a hazardous substance, safety dictates that it is not prudent to carry tanks of pressurised ammonia onboard a vehicle, thus it is necessary to produce ammonia in situ.

Known systems of producing ammonia on board a vehicle principally fall into one of two categories: those which produce gaseous ammonia and introduce the gas into the exhaust conduit, and those which introduce into the exhaust conduit a liquid reagent which decomposes into ammonia gas in the exhaust conduit.

One method of producing ammonia onboard has been proposed in U.S. Pat. No. 6,361,754 and comprises a spiral hydrolysis reactor that decomposes urea into at least gaseous ammonia. While theoretically this is an efficient method of preparing ammonia gas in situ, the coiled design of the reactor is problematic because, as gas breaks out of the liquid bubbles will be formed at the top of the loops of the reactor coil which, as the bubbles expand, will tend to unpredictably expel remaining fluid from the reactor coil

It is the purpose of the present invention to provide an improved reactor for the thermo-hydrolysis of a reagent that is suitable for use on board a vehicle. According to the present invention there is provided a thermo-hydrolysis reactor for producing ammonia-containing gas by heating an aqueous solution of urea or the like, the reactor comprising an elongate vessel having a middle tubular section, an enlarged lower section having an inlet therein for the solution, and an enlarged upper section having an outlet therein for the ammonia-containing gas, said reactor being adapted such that, in use, heat transmitted through the walls of the reactor from an external heat source heats the solution therein causing it to hydrolyse producing said ammonia-containing gas.

The reactor is designed for use with liquid reagents which hydrolyse to form ammonia-containing gas; in particular the reactor is designed for use with aqueous solutions containing urea or related substance such as biuret or ammonium carbamate, collectively referred to, and defined, herein as “urea”.

Preferably, in use, the thermo-hydrolysis reactor is heated by heat exchange with the hot exhaust gasses of an internal combustion engine.

Preferably the level of the aqueous solution of urea in the reactor is variable and the reactor is configured such that, as the level of the aqueous solution of urea in the reactor increases, the wetted surface area to volume ratio of the reactor also increases.

In a preferred arrangement the enlarged lower section has conical sides and the ratio of the maximum diameter of the lower conical section to the diameter of the tubular section, and the angle of the sides of the lower conical section, define the relationship between fill level and wetted surface area of the reactor.

Preferably the reactor is provided with a level sensor to detect the level of the reagent within the reactor. In one arrangement the level sensor passes through the lower end of the reactor and extends substantially vertically upwards into it, thereby maintaining the majority of the sensor substantially at the temperature of the liquid within the reactor. Alternatively the level sensor passes through the upper end of the reactor and extends substantially vertically downwards into it.

Preferably, situated within the reactor below the level of the outlet and above the level of the solution is a baffle to prevent splashes of aqueous urea from entering the ammonia-containing gas outlet.

Preferably a catalyst is placed in the reactor vessel to promote the hydrolysis of the aqueous solution of urea. More preferably the catalyst extends from below the level of the aqueous solution of urea within the reactor to above the level of the aqueous solution of urea thereby enabling the contact area of the catalyst to be varied by changing the volume of aqueous solution of urea within said reactor

Additionally the reactor may have a plurality of heat exchange fins on its exterior and/or interior. In one preferred arrangement the heat exchange fins placed on the interior of the reactor are made of a hydrolysis catalyst.

Preferably the reactor is provided with a supplementary heater such that, if necessary, the reactor may be heated by both heat exchange with the exhaust gas and the supplementary heater.

Preferably the reactor is provided with temperature and pressure sensors to sense the temperature and pressure within the reactor.

According to the present invention there is also provided a NOx-reduction system including a reactor as defined above and a road vehicle containing such a system.

Embodiments of the invention will now be described by way of example only, with reference to the accompanying drawings in which;

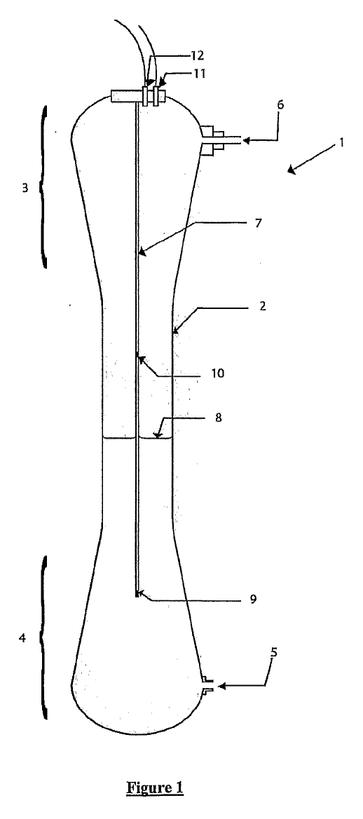

FIG. 1 is a cross section of a reactor according to the invention;

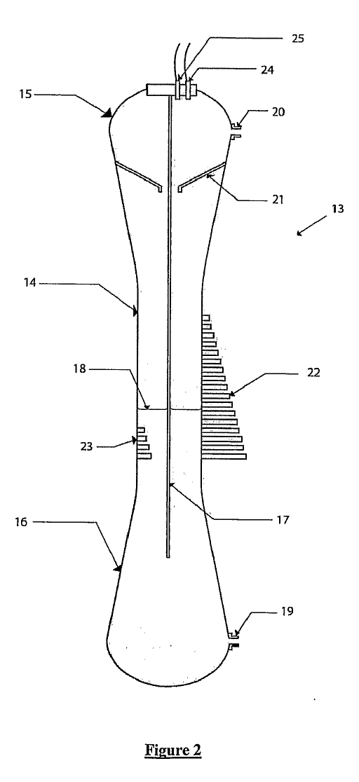

FIG. 2 is a cross section of a reactor of the invention with heat exchange fins;

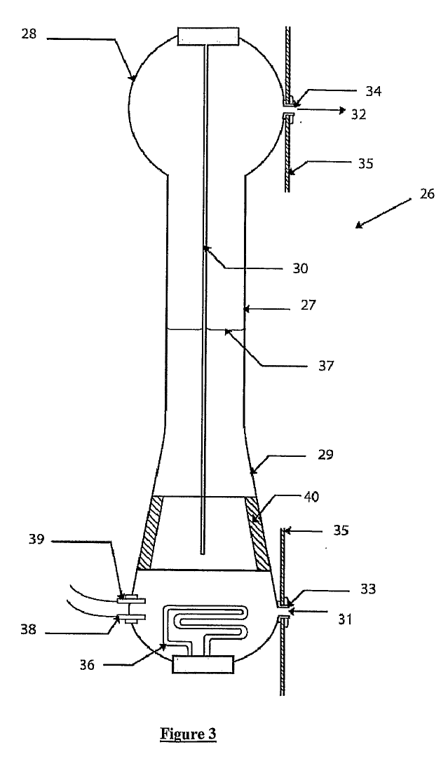

FIG. 3 is an cross section of an alternative reactor of the invention with a supplementary heater; and

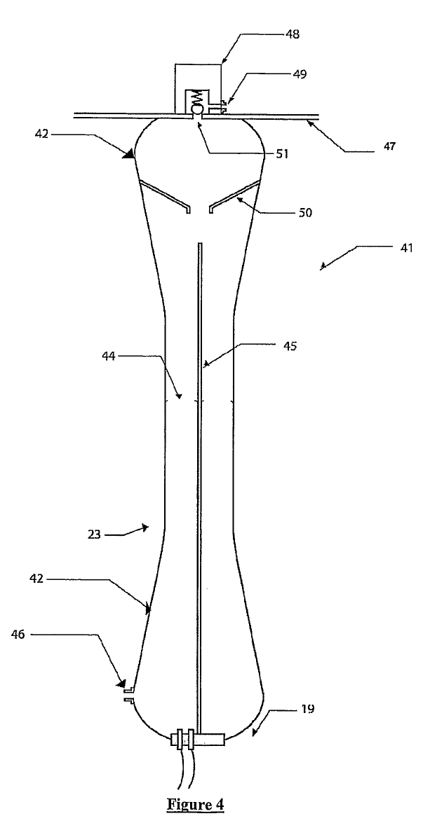

FIG. 4 is a cross section of another reactor of the invention.

Referring to FIG. 1 a thermo-hydrolysis reactor 1 is shown, capable of being placed in-line in the exhaust conduit of an IC engine, for example that found on a diesel vehicle, upstream of a selective catalytic reduction (SCR) catalyst. The thermo-hydrolysis reactor 1 produces an ammonia-containing gaseous product which is added to the exhaust gas in a controlled manner to pass therewith through an SCR catalyst to reduce the NOx content of the exhaust gas. The reactor 1 comprises an elongate body 2 with a tubular middle section and enlarged upper 3 and lower 4 sections. The reactor 1 is provided with an inlet 5 for the supply of aqueous urea solution and an outlet 6 for the removal of the ammonia-containing gas. The release of the ammonia-containing gas via the outlet 6 is controlled by a pressure control valve in the outlet line (not shown). Entering the reactor 1 from the top is a level sensor 7, the output of which is used to control a pump (not shown) supplying inlet 5 to maintain the urea liquid level 8 between lower 9 and upper 10 liquid level measurement points. Also entering the top of the reactor are a pressure 11 and temperature 12 sensor. In use, the reactor 1 is heated by heat transfer with hot exhaust gas. The aqueous solution of urea becomes heated and starts to decompose forming hydrolysis gasses comprising ammonia, carbon dioxide and steam. As the hydrolysis gases collect in the upper section 3 of the reactor they are prevented from leaving by the pressure control valve in the outlet line and thus the pressure in the reactor increases to the set pressure of the control valve. The increase in pressure allows for a further increase in temperature, the increased temperature and pressure resulting in a shortened hydrolysis time. Eventually the pressure in the reactor 1 exceeds the set pressure of the pressure control valve whereby “excess” ammonia-containing gas issues from the outlet 6 via the control valve for use in the SCR process. A reactor of this design is particularly appropriate for use in a mobile application, for example on board commercial vehicle as, due to its tall, thin geometry, the liquid level in the reactor will remain substantially unaffected by such factors as the vehicle being on an incline, centrifugal force of the vehicle following a radial path or the reagent sloshing due to uneven motion of the vehicle. All the sensors 7, 11, 12 comprise a single sub assembly which is attached to the reactor at one end, thereby giving a single access point enabling simple replacement should any of the sensors fail.

Referring to FIG. 2 a reactor 13 for use in a gas treatment apparatus is shown comprising an elongate body 14 with a bulbous head section 15 and a conical lower section 16. During use the reactor 13 is heated by heat transfer from the hot exhaust gasses of an engine (not shown) to hydrolyse the aqueous urea therein. The reactor 13 has a level sensor 17 entering at its top and extending downwards therefrom into the aqueous urea within the reactor 13. The liquid level sensor 17 is situated on the central axis of the reactor 13. By placing the liquid level sensor 17 on the central axis as the liquid moves slightly from side to side the level at the central axis should not change significantly. Preferably the liquid level sensor 17 measures the liquid level 18 on a continuous scale. The reactor 13 has an inlet 19 for the supply of pressurised aqueous urea and an outlet 20 which leads to a pressure control valve (not shown). The reactor 13 has a baffle 21 situated in its head section 15 above the liquid level and below the outlet 20. In the event of any splashing of the reagent within the reactor 13, for example due to motion of the vehicle the baffle 21 prevents splashes of liquid from exiting from the outlet 20. The liquid level 18 may be controlled by controlling the volume of aqueous urea pumped into the reactor via inlet 19 dependant on the sensed liquid level. The heat transfer from the hot exhaust gas is dependent on the wetted surface area of the reactor 13. The geometry of the conical section 16 allows for a specific non linear relationship of heat transfer to liquid level to be achieved. To assist heat transfer from the exhaust gas to the reactor 13 a number of heat exchange fins 22 are shown on the external surface of the reactor 13. The surface area of the fins 22 changes in relation to the height of the reactor 13 and thus the heat input to the aqueous urea can be controlled by varying the liquid level 18. For additional heat transfer to the liquid heat exchange fins 23 fins are shown inside the reactor 13 to increase the contact surface area between the reactor body 14 and the aqueous urea within the reactor 13. The reactor 13 is also provided with temperature 24 and pressure 25 sensors to monitor the temperature and pressure of the gas within the reactor 13.

Referring to FIG. 3 a reactor 26 for use in a gas treatment apparatus is shown comprising an elongate body 27 with a bulbous head section 28 and a conical lower section 29. During use the reactor 26 is heated by heat transfer from the hot exhaust gasses of an engine (not shown) to hydrolyse the aqueous solution of urea therein. The reactor has a level sensor 30 entering at its top and extending downwards therefrom into the aqueous solution of urea within the reactor. The reactor 26 has an inlet 31 in the lower section 29 and an outlet 32 in the upper section 28, said inlet 31 and outlet 32 comprising bulkhead fittings 33, 34 for attaching the reactor to a bulkhead 35 which may for example be the exhaust conduit. The lower section 29 of the reactor 26 contains a supplementary heating element 36 which is situated below the liquid level 37, said liquid level 37 being maintained within a range detected by the liquid level sensor 30. The supplementary heater 36 is used during start up to enhance the heating capacity of the hot exhaust gas to decrease the time taken for the reactor 26 to reach its operating conditions of temperature and pressure measured by temperature and pressure sensors 38, 39. Outlet 32 leads to a pressure controller which, in use, maintains an elevated pressure within the reservoir 26. A hydrolysis catalyst 40, for example tungsten vanadium, is provided within the reactor below the level 37 of the urea solution. Alternatively (not shown) the catalyst may extend from below the liquid level to above the liquid level whereby variation of the liquid level exposes the aqueous urea to a greater or a lesser surface area of the catalyst.

Referring to FIG. 4 a generally elongate reactor 41 is shown having an enlarged upper section 42 and lower section 43. The reactor 41 contains an aqueous solution of urea up to a level 44 detected by level sensor 45 which extends upwards from the bottom of the reactor 41. The reactor has an aqueous urea inlet 46 in its lower section for supplying the reactor with a supply of aqueous urea which in use, becomes heated by means of heat exchange with hot exhaust gas through the walls of the reactor 41. The reactor 41 is attached at its upper end to the exhaust conduit 47 and a pressure regulating valve 48, situated outside the conduit 47 is in communication with the interior of the reactor 41 through the conduit 47. The valve 48 has an outlet 49 through which the ammonia containing hydrolysis gas passes for use in SCR of NOx in exhaust gasses. The reactor 41 has a slosh baffle 50 to help prevent splashes of the aqueous solution from entering the valve via the reactor outlet 51.

A reactor of the invention is especially, but not exclusively, designed for use in the NOx-reducing systems and apparatus disclosed in our co-pending PCT applications of even date herewith.

It will be appreciated that within the scope of the invention various components described herein with reference to one or other of the embodiments are interchangeable. For example systems falling within the scope of the invention may include a combination of features not explicitly described in respect to any particular embodiment.

1. A thermo-hydrolysis reactor for producing ammonia-containing gas by heating an aqueous solution of urea (as hereinbefore defined), the reactor comprising an elongate vessel having a middle tubular section, an enlarged lower section having an inlet therein for the solution, and an enlarged upper section having an outlet therein for the ammonia-containing gas, said reactor being adapted such that, in use, heat transmitted through the walls of the reactor from an external heat source heats the solution therein causing it to hydrolyse producing said ammonia-containing gas.

2. The thermo-hydrolysis reactor as claimed in claim 1 wherein, in use, the reactor is heated by heat exchange with the hot exhaust gasses of an internal combustion engine.

3. The thermo-hydrolysis reactor as claimed in claim 1 wherein the reactor is configured such that, as the level of the aqueous solution of urea in the reactor increases, the wetted surface area to volume ratio of the reactor also increases.

4. The thermo-hydrolysis reactor as claimed in claim 1, wherein the enlarged lower section has conical sides.

5. The thermo-hydrolysis reactor as claimed in claim 4 wherein the ratio of the maximum diameter of the lower conical section to the diameter of the tubular section and the angle of the sides of the lower conical section define the relationship between fill level and wetted surface area of the reactor.

6. The thermo-hydrolysis reactor as claimed in any claim 1 wherein the reactor has a level sensor.

7. The thermo-hydrolysis reactor as claimed in claim 6 wherein the level sensor passes through the lower end of the reactor and extends substantially vertically upwards into it.

8. The thermo-hydrolysis reactor as claimed in claim 6 wherein the level sensor passes through the upper end of the reactor and extends substantially vertically downwards into it.

9. The thermo-hydrolysis reactor as claimed in claim 1, wherein situated below the level of the outlet and above the level of the solution within the reactor is a baffle to prevent splashes of aqueous urea from entering the ammonia containing gas outlet.

10. The thermo-hydrolysis reactor as claimed in claim 1, wherein a hydrolysis catalyst is present in the reactor vessel to promote the hydrolysis of the aqueous solution of urea.

11. The thermo-hydrolysis reactor as claimed in claim 10 wherein the catalyst extends from below the level of the aqueous solution of urea within the reactor to above the level of the aqueous solution of urea thereby enabling the contact area of the catalyst to be varied by changing the volume of aqueous solution of urea within said reactor.

12. The thermo-hydrolysis reactor as claimed in claim 1, wherein the reactor vessel has a plurality of heat exchange fins on its exterior and/or interior.

13. The thermo-hydrolysis reactor as claimed in claim 12 wherein any internal heat exchange fins comprise a hydrolysis catalyst.

14. The thermo-hydrolysis reactor as claimed in claim 1 wherein, in use, the reactor is heated by heat exchange with the hot exhaust gasses of an internal combustion engine and wherein the reactor is provided with a supplementary heater such that, if necessary, the reactor may be heated by both heat exchange with the exhaust gas and the supplementary heater.

15. A NOx-reduction system including a thermo-hydrolysis reactor for producing ammonia-containing gas by heating an aqueous solution of urea (as hereinbefore defined), the reactor comprising an elongate vessel having a middle tubular section, an enlarged lower section having an inlet therein for the solution, and an enlarged upper section having an outlet therein for the ammonia-containing gas, said reactor being adapted such that, in use, heat transmitted through the walls of the reactor from an external heat source heats the solution therein causing it to hydrolyse producing said ammonia-containing gas.

16. A road vehicle including a NOx-reduction system comprising a thermo-hydrolysis reactor for producing ammonia-containing gas by heating an aqueous solution of urea (as hereinbefore defined), the reactor comprising an elongate vessel having a middle tubular section, an enlarged lower section having an inlet therein for the solution, and an enlarged upper section having an outlet therein for the ammonia-containing gas, said reactor being adapted such that, in use, heat transmitted through the walls of the reactor from an external heat source heats the solution therein causing it to hydrolyse producing said ammonia-containing gas.
